(19) United States
(12) Patent Application Publication
(10) Pub. No.: US 2009/0268910 A1
(43) Pub. Date: Oct. 29, 2009

(54) Apparatus and method for initialization of a scrambling sequence for a downlink reference signal in a wireless network

(75) Inventors: Lingjia Liu, Plano, TX (US); Jianzhong Zhang, Irving, TX (US); Yingyang Li, Beijing (CN); Farooq Khan, Allen, TX (US)

Correspondence Address: Docket Clerk, P.O. Drawer 800889, Dallas, TX, 75380, US

(73) Assignee: Samsung Electronics Co., Ltd., Gyeonggi-do (KR)

(21) Appl. No.: 12/313,223

(22) Filed: Nov. 18, 2008

Related U.S. Application Data
(60) Provisional application No. 61/071,426, filed on Apr. 28, 2008.
(60) Provisional application No. 61/129,123, filed on Jun. 5, 2008.

(51) Int. Cl. H04K 1/04; H04L 9/00

(52) U.S. Cl. 380/268; 380/270

(57) ABSTRACT

A method for generating a variable reference signal is provided. The method comprises initializing a scrambling sequence generator at the start of a 10 millisecond (ms) radio frame. The variable reference signal is generated for the radio frame based on different antenna ports, sequence length per antenna port and an initialization seed constructed with a specified equation. Additionally, the variable reference signal is initialized at the start of a 1 ms radio subframe based on a constructed initialization seed.

### CROSS-REFERENCE TO RELATED APPLICATION(S) AND CLAIM OF PRIORITY

The present application is related to U.S. Provisional Patent No. 61/071,426, filed Apr. 28, 2008, entitled “INITIALIZATION OF THE SCRAMBLING SEQUENCE FOR DOWNLINK REFERENCE SIGNAL” and U.S. Provisional Patent No. 61/129,123, filed Jun. 5, 2008, entitled “INITIALIZATION OF THE SCRAMBLING SEQUENCE FOR DOWNLINK REFERENCE SIGNAL.” Provisional Patent Nos. 61/071,426 and 61/129,123 are assigned to the assignee of the present application and are hereby incorporated by reference into the present application as if fully set forth herein. The present application hereby claims priority under 35 U.S.C. §119(e) to U.S. Provisional Patent Nos. 61,071,426 and 61/129,123.

### TECHNICAL FIELD OF THE INVENTION

The present application relates generally to wireless communications and, more specifically, to reference signal generation in wireless communications networks.

### BACKGROUND OF THE INVENTION

The Third Generation Partnership Project (3GPP) is a collaboration between groups of telecommunications associations, to make a globally applicable third generation (3G) mobile phone system specification within the scope of the International Mobile Telecommunications-2000 project of the International Telecommunication Union. Within 3GPP, Long Term Evolution (LTE) is a project within 3GPP to improve the Universal Mobile Telecommunications System (UMTS) mobile phone standard to cope with future technology advancements. The LTE physical layer is based on Orthogonal Frequency Division Multiplexing scheme (OFDM) to meet the targets of high data rate and improved spectral efficiency. The spectral resources are allocated/used as a combination of both time (e.g., slot) and frequency units (e.g., subcarrier). The smallest unit of allocation is termed as a resource block. A resource block spans 12 sub-carriers with a sub-carrier bandwidth of 15 KHz (effective bandwidth of 180 KHz) over a slot duration.

The general structure of a downlink physical channel is illustrated in FIG. 2. The downlink physical channel corresponds to a set of resource elements carrying information originating from higher layers. A baseband signal representing a downlink physical channel is defined in terms of the following steps: in step 202, scrambling of coded bits in each of the code words to be transmitted on a physical channel; in step 204, modulation of scrambled bits to generate complex-valued modulation symbols; in step 206, mapping of the complex-valued modulation symbols onto one or several transmission layers; in step 208, preceding of the complex-valued modulation symbols on each layer for transmission on the antenna ports; in step 210; mapping of complex-valued modulation symbols for each antenna port to resource elements; and in step 212, generation of complex-valued time-domain OFDM signal for each antenna port.

Additionally, a downlink physical signal corresponds to a set of resource elements used by the physical layer but does not carry information originating from higher layers. The following downlink physical signals are defined: Synchronization signal and Reference signal.

Primary and secondary synchronization signals are transmitted at a fixed subframes (first and sixth) position in a frame and assists in the cell search and synchronization process at the user terminal. Each cell is assigned unique Primary sync signal.

The reference signal consists of known symbols transmitted at a well defined OFDM symbol position in the slot. This assists the receiver at the user terminal in estimating the channel impulse response to compensate for channel distortion in the received signal. There is one reference signal transmitted per downlink antenna port and an exclusive symbol position is assigned for an antenna port (when one antenna port transmits a reference signal other ports are silent).

Reference signals (RS) are used to determine the impulse response of the underlying physical channels. For downlink (DL) cell-specific reference signal, the initialization method for the lower register is shown to be:

cᵢₙᵢₜ=Cell_ID+Subfram_Num×2⁹+OFDM_Symbol_Num×2¹³, [Eqn. 1]

where N_{ID}^{Cell} is the cell_ID, N_{Num}^{Subfram} is the subframe number, and N_{Num}^{Symbol} is the OFDM symbol number, and the pseudo-random binary sequence (PRBS) is initialized by:

cᵢₙᵢₜ=N_{ID}^{Cell}+N_{Num}^{Subfram}×2⁹+N_{Num}^{Symbol}×2¹³, [Eqn. 2]

as illustrated in FIG. 3.

However, this initialization method will result in the output x₂(n) being a linear function of the initial seed cᵢₙᵢₜ. Therefore, this initialization offers no separation for the pseudo-random sequence in time (e.g., for a given resource element (RE), if the scrambling sequence for two cells is the same on one OFDM symbol, then it will be the same for all OFDM symbols). Thus, the reference signal structure offers no time diversity while differentiating between two cell IDs. This effect will have a crucial impact on the channel estimation.

Therefore, there is a need in the art for an improved reference signal generation. In particular, there is a need for an improved scrambling sequence generator that is capable of generating a reference signal from an initialization seed that provides time diversity as well as cell ID diversity.

### SUMMARY OF THE INVENTION

A base station capable of generating a reference signal in a wireless communication network is provided. The base station comprises a scrambling sequence generator adapted to be initialized at the start of a ten (10) millisecond (“ms”) radio frame. The scrambling sequence generator is further adapted to generate a reference signal for the radio frame based on different antenna ports. In some embodiments, the scrambling sequence generator is further adapted to generate a reference signal for the radio frame based on different antenna ports transmitting a different sequence length. In some embodiments, the scrambling sequence generator is further adapted to generate a reference signal for the radio frame based on different antenna ports transmitting a same sequence length.

A base station capable of generating a reference signal in a wireless communication network is provided. The base station comprises scrambling sequence generator adapted to be initialized at the start of a one (1) ms radio subframe. The scrambling sequence generator is further adapted to generate a reference signal for the radio frame based on an initialization seed constructed through a convolutional code. In some embodiments, the scrambling sequence generator is adapted to generate a reference signal based on an initialization seed constructed with a specified equation. In some embodiments, the scrambling sequence generator is further adapted to generate a reference signal based on an initialization seed constructed via a Bits Map process and Random Mapping process.

A method for generating a reference signal is provided. The method comprises initializing a scrambling sequence generator at the start of a ten (10) ms radio frame. A reference signal is generated, by the scrambling sequence generator, for the radio frame based on different antenna ports. In some embodiments, the reference signal is generated, by the scrambling sequence generator, for the radio frame based on based on an initialization seed constructed with a specified equation. In some embodiments, the reference signal is generated, by the scrambling sequence generator, for the radio frame based on different antenna ports transmitting a same sequence length.

An alternate method for generating a reference signal is provided. The method comprises initializing a scrambling sequence generator at the start of a one (1) ms radio subframe. A reference signal is generated, by the scrambling sequence generator, for the radio frame based on an Initialization seed constructed through a convolutional code. In some embodiments, the reference signal is generated, by the scrambling sequence generator, for the radio frame based on an initialization seed constructed with a specified equation. In some embodiments, the reference signal is generated, by the scrambling sequence generator, for the radio frame based on an initialization seed constructed via a Bits Map process and Random Mapping process.

To address the above-discussed deficiencies of the prior art, it is a primary object to provide a scrambling sequence generator, for use in a wireless communication network.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (“OFDMA”) wireless network that is capable of decoding data streams according to one embodiment of the present disclosure;

FIG. 2 illustrates an Overview of Physical Channel Processing of an OFDMA transmitter according to an exemplary embodiment of the present disclosure;

FIG. 3 illustrates an Initialization for a Downlink Cell-Specific Reference Signal according to an exemplary embodiment of the present disclosure;

FIG. 4 illustrates a Gold Sequence generation diagram according to an exemplary embodiment of the present disclosure;

FIG. 5 illustrates an exemplary frame diagram according to an embodiment of the present disclosure;

FIGS. 6 and 7 illustrate simple block diagrams for generation of an initialization seed according to embodiments of the present disclosure; and

FIGS. 8 and 9 illustrate process for generating reference signals according to embodiments of the present disclosure.

### DETAILED DESCRIPTION OF THE INVENTION

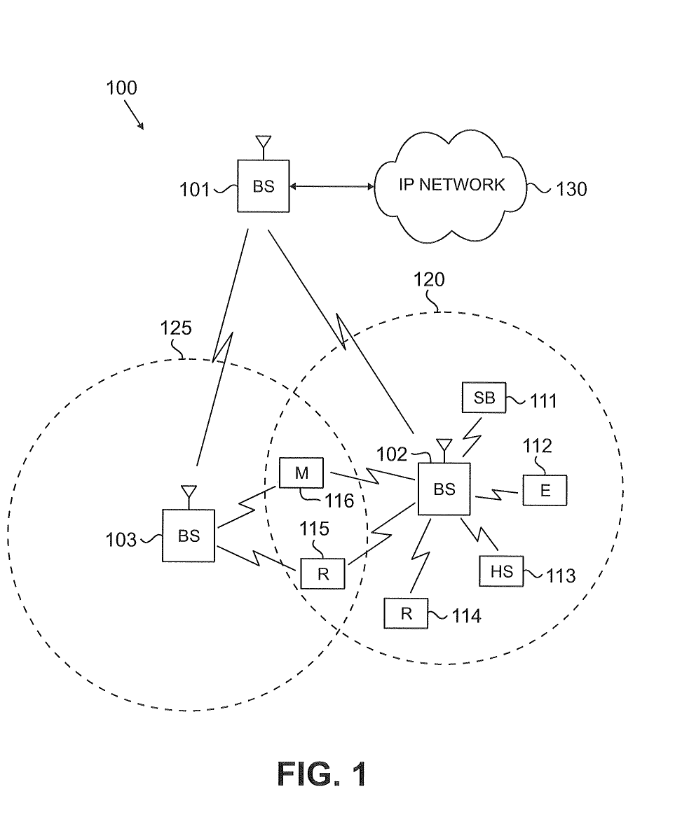

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication network.

It is noted that the term “base station” is used below to refer to infrastructure equipment that is often referred to as “node B” in LTE standards and other literature. Also, the term “subscriber station” is used herein in place of the conventional LTE terms “user equipment” or “UE”. This use of interchangeable terms should not be construed so as to narrow the scope of the claimed invention.

FIG. 1 illustrates exemplary wireless network 100 that transmits reference signals according to principles of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, cafe, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random order without being as complex as a receiver that searches all possible decoding orders to find the optimum order.

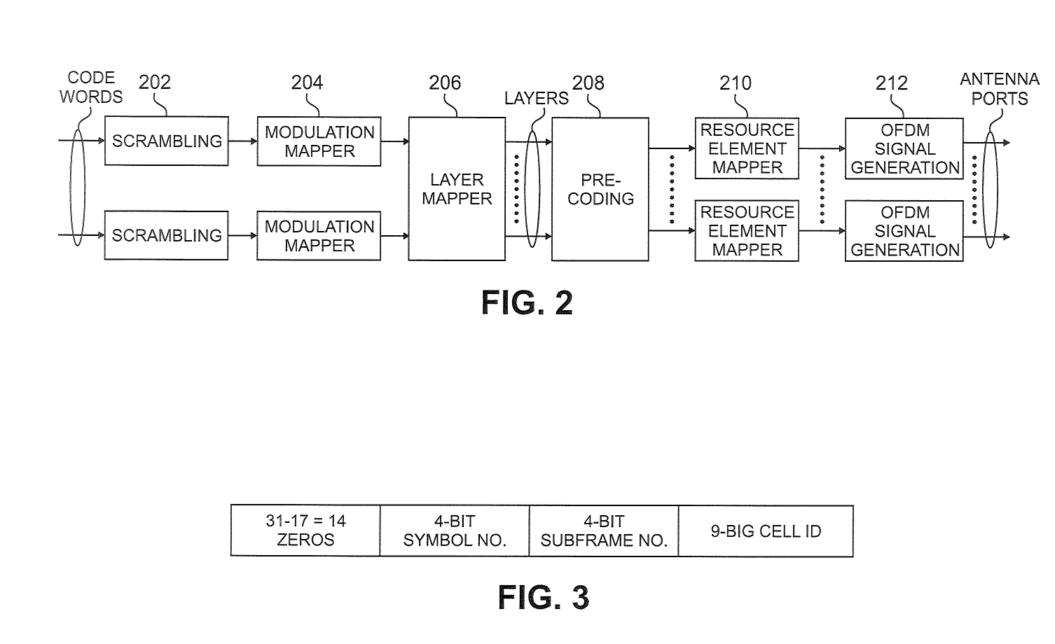

In FIG. 2, the physical downlink processing in an OFDMA transmit path is implemented in base station (BS) 102 for the purposes of illustration and explanation only. However, it should be understood by those skilled in the art that the OFDMA transmit path may also be implemented in SS 116 or in a relay station (not specifically illustrate).

FIG. 2 illustrates an overview of physical channel processing for a general structure for downlink physical channels. It should be understood that this general structure is equally applicable to more than one physical channel.

Scrambling occurs in the scrambling sequence generator 202. For each code word q, the block of bits b^{(q)}(0), . . . , b^{(q)}(M_{bit}^{(q)}-1), where M_{bit}^{(q)} is the number of bits in code word q transmitted on the physical channel in one subframe, shall be scrambled prior to modulation 204, resulting in a block of scrambled bits \tilde{b}^{(q)}(0), . . . ,\tilde{b}^{(q)}(M_{bit}^{(q)}-1) according to:

\tilde{b}^{q}(i)=(b^{q}(i)+c^{q}(i))mod2. [Eqn. 3]

In Equation 3, c^{q}(i) is referred to as the pseudo-random scrambling sequence. The scrambling sequence generator 202 is initialized at the start of each subframe.

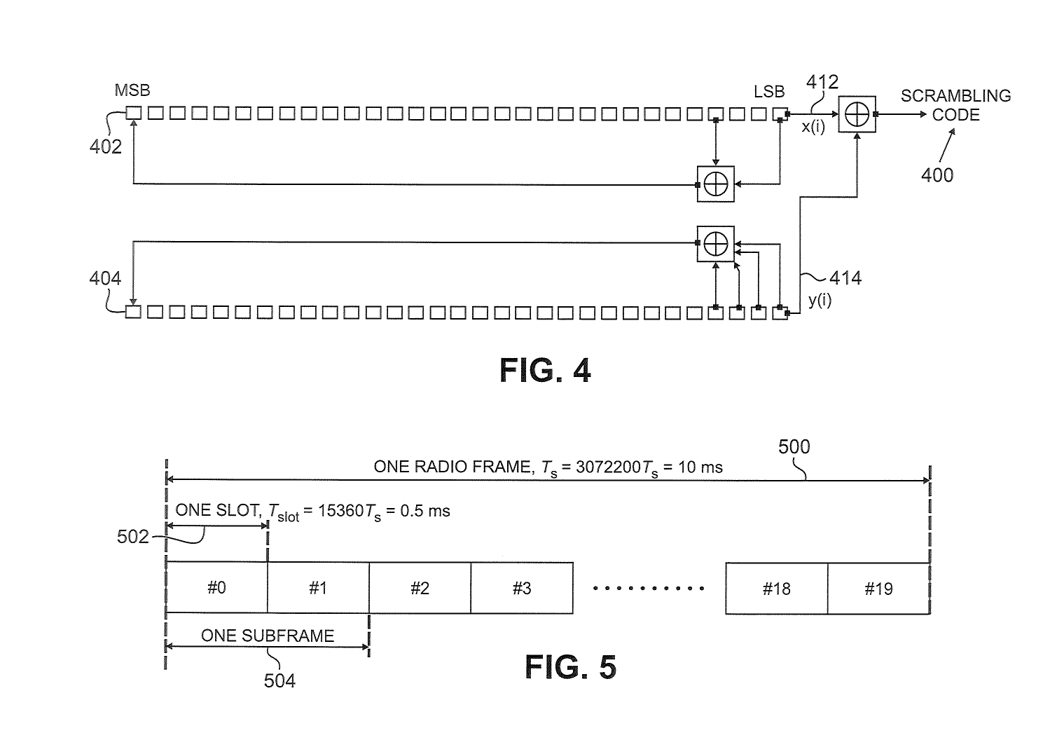

In some embodiments, the scrambling sequence generator 202 utilizes Gold codes to generate and initialize scrambling Code 400 sequences. In FIG. 4, Gold codes are utilized based on feedback polynomial degree L=31 (i.e., length=31) with the following generator polynomials:

1) D31+D3+1 for the top register 402, generating the sequence x(i) 412; and

2) D31+D3+D2+D+1 for the lower register 404, generating the sequence y(i) 414.

The top register 402 is initialized by filling the top register 402 with the following fixed pattern x(0)=1(MSB), and x(1)= . . . =x(30)=0. The lower register 404 is initialized by filling the lower register 404 with the initialization sequence based on the application of the sequence.

The output of the pseudo-random sequence generation is defined by:

c(n)=(x₁(n+N_{c})+x₂(n+N_{c}))mod2 [Eqn. 4]

x₁(n+31)=(x₁(n+3)+x₁(n))mod2 [Eqn. 5]

x₂(n+31)=(x₂(n+3)+x₂(n+2)+x₂(n+1)+x₂(n))mod2 [Eqn. 6]

In Equations 4, 5 and 6, N_{c}=1600.

FIG. 5 illustrates a Type-1 frame structure according to embodiments of the present disclosure. The size of various fields in the time domain is expressed as a number of time units Tₛ=1/(15000×2048) seconds. Downlink and uplink transmissions are organized into radio frames with T_{f}=307200×Tₛ=10 ms duration. Two radio frame structures are supported: Type-1, applicable to FDD; and Type-2, applicable to TDD. It should be understood that illustration of a Type-1 frame merely is exemplary and embodiments of the present disclosure apply equally to Type-2 frames.

Frame structure type-1 is applicable to both full duplex and half duplex FDD. Each radio frame 500 is T_{f}=307200·Tₛ=10 ms long and consists of twenty (20) slots 502 of length Tₛₗₒₜ=15360·Tₛ=0.5 ms, numbered from zero (0) to nineteen (19). A subframe 504 is defined as two (2) consecutive slots where subframe i consists of slots 2i and 2i+1.

For FDD, ten (10) subframes 504 are available for downlink transmission and ten (10) subframes 504 are available for uplink transmissions in each ten (10) ms interval. Uplink and downlink transmissions are separated in the frequency domain. In half-duplex FDD operation, SS 116 cannot transmit and receive at the same time while there are no such restrictions in full-duplex FDD.

One reference signal is transmitted per downlink antenna port. Additionally, there are three (3) types of reference signals. These reference signals are: Cell-specific reference signals, associated with non Multi-Broadcast Single Frequency Network (hereinafter “MBSFN”) transmission; MBSFN reference signals, associated with MBSFN transmission; and UE-specific reference signals.

Cell-Specific Reference Signals

Cell-specific reference signals are transmitted in all downlink subframes 504 in a cell supporting non-MBSFN transmission. In case the subframe 504 is used for transmission with MBSFN, the first two OFDM symbols in a subframe 504 can be used for transmission of cell-specific reference symbols.

Cell-specific reference signals are transmitted on one or several of antenna ports zero (0) to three (3). Additionally, Cell-specific reference signals are defined for Δf=15 kHz.

For cell-specific reference signals, the scrambling sequence generator 202 generates the reference signal sequence r_{l,n}_{ₛ}(m). The reference signal sequence r_{l,n}_{ₛ}(m) is defined by:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 {N}_{RB}^{max , DL} - 1 \qquad [ Eqn . 7 ]$$

In Equation 7, nₛ is the slot number 502 within a radio frame 500 and l is an OFDM symbol number within the slot 502. The pseudo-random sequence c(i) is defined by Equations 4, 5 and 6 discussed herein above. The pseudo-random sequence generator is initialized with cᵢₙᵢₜ=2¹³·l′+2⁹·└nₛ/2┘+N_{ID}^{cell} at the start of each OFDM symbol, where l′=(nₛmod2)·N_{symb}^{DL}+l is the symbol number within a subframe 504.

In one embodiment, the pseudo-random sequence generator is initialized at the start of each frame 500. In such embodiment, the scrambling sequence generation for downlink cell-specific reference signals is changed. The new cell-specific reference signal sequence r_{l,n}_{ₛ}(m) is defined by:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 \cdot e \cdot {N}_{RB}^{max , DL} - 1. \qquad [ Eqn . 8 ]$$

In Equation 8, e=40 for antenna ports zero (0) and one (1) while e=20 for antenna ports two (2) and three (3). Further, nₛ is the slot number 502 within a radio frame 500 and l is an OFDM symbol within the slot 502. The pseudo-random sequence c(i) is defined by Equations 4, 5 and 6 discussed herein above. The pseudo-random sequence generator is initialized with cᵢₙᵢₜ=N_{ID}^{cell} at the start of each frame 500 (e.g., at the start of each 10 ms frame 500). Thus, the new reference signal sequence is variable by frame. Additionally, by generating the reference signal sequence by frame, the sequence is divided over the entire frame and each subframe can contain a different portion (e.g., “chunk”) of the new reference signal sequence. As such, the new reference signal sequence will vary over each subframe.

In an additional embodiment, the scrambling sequence generation for downlink cell-specific reference signals is changed wherein different antenna ports have different lengths of the sequence. In such embodiment, the new cell-specific reference signal sequence r_{l,n}_{ₛ}(m) is defined by:

$${r}_{l , {n}_{s}} ( m ) = \frac{1}{\sqrt{2}} ( 1 - 2 \cdot c ( 2 m + {l}^{′} ) ) + j \frac{1}{\sqrt{2}} ( 1 - 2 \cdot c ( 2 m + 1 + {l}^{′} ) ) , \\ for m = 0 , 1 , … , 2 \cdot {N}_{RB}^{max , DL} - 1. \qquad [ Eqn . 9 ]$$

In Equation 9, nₛ is the slot number 502 within a radio frame 500 and l is an OFDM symbol within the slot 502. Further, l′ is defined as follows:

$${l}^{′} = \{ \begin{matrix}4 {N}_{RB}^{max , DL} \cdot ( 2 {n}_{s} + ⌊ \frac{2 l}{{N}_{symb}^{DL}} ⌋ ) & for & {R}_{0} \& {R}_{1} \\ 4 {N}_{RB}^{max , DL} \cdot ( {n}_{s} + ⌊ \frac{2 l}{{N}_{symb}^{DL}} ⌋ ) & for & {R}_{2} \& {R}_{3}\end{matrix} \qquad [ Eqn . 10 ]$$

The notation R_{P} denotes a resource element used for reference signal transmission on antenna port P. The pseudo-random sequence c(i) is defined by Equations 4, 5 and 6 discussed herein above. The pseudo-random sequence generator is initialized with cᵢₙᵢₜ=N_{ID}^{cell} at the start of each frame 500 (e.g., at the start of each 10 ms frame 500). Thus, the new reference signal sequence is variable by more than the cell ID (e.g., variable by antenna and over different frames).

In another embodiment, the scrambling sequence generation for downlink cell-specific reference signals is changed wherein different antenna ports have the same lengths of the sequence. In such embodiment, the new cell-specific reference signal sequence r_{l,n}_{ₛ}(m) is defined by Equation 9, discussed herein above.

However, in such embodiment, l′ is defined by Equation 11 as follows:

$${l}^{′} = 4 {N}_{RB}^{max , DL} \cdot ( 2 {n}_{s} + ⌊ \frac{2 l}{{N}_{symb}^{DL}} ⌋ ) \cdot \qquad [ Eqn . 11 ]$$

The pseudo-random sequence c(i) is defined by Equations 4, 5 and 6 discussed herein above. The pseudo-random sequence generator is initialized with cᵢₙᵢₜ=N_{ID}^{cell} at the start of each frame 500 (e.g., at the start of each 10 ms frame 500).

In an additional embodiment, the scrambling sequence generation for downlink cell-specific reference signals is changed with a new logic incorporated. In such embodiment, the new cell-specific reference signal sequence r_{l,n}_{ₛ}(m) is defined by:

$${r}_{l , {n}_{s}} ( m ) = \frac{1}{\sqrt{2}} ( 1 - 2 \cdot c ( 2 m + {N}_{c}^{′} ) ) + j \frac{1}{\sqrt{2}} ( 1 - 2 \cdot c ( 2 m + 1 + {N}_{c}^{′} ) ) , \\ for m = 0 , 1 , … , 2 \cdot {N}_{RB}^{max , DL} - 1. \qquad [ Eqn . 12 ]$$

In Equation 12, ns is the slot number 502 within a radio frame 500 and l is an OFDM symbol within the slot 502. Further, l′ is defined as follows:

N′_{c}=mod(N_{ID}^{Cell}×(16×l+N_{Num}^{Subfram}), 509). [Eqn. 13]

The pseudo-random sequence c(i) is defined by Equations 4, 5 and 6 discussed herein above. The pseudo-random sequence generator is initialized with cᵢₙᵢₜ=N_{ID}^{cell} at the start of each OFDM symbol or each frame 500. Therefore, a different subsequence of the reference signal sequence is applied to each subframe.

MBFSN Reference Signals

For MBSFN reference signals, the scrambling sequence generator 202 generates the reference signal sequence r_{l,n}_{ₛ}(m). The reference signal sequence r_{l,n}_{ₛ}(m) is defined by:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 6 {N}_{RB}^{max , DL} - 1. \qquad [ Eqn . 14 ]$$

In Equation 14, nₛ is the slot number 502 within a radio frame 500 and l is an OFDM symbol number within the slot 502. The pseudo-random sequence c(i) is defined by Equations 4, 5 and 6 discussed herein above. The pseudo-random sequence generator is initialized with cᵢₙᵢₜ=2¹³·l′+2⁹·└nₛ/2┘+N_{ID}^{MBSFN} at the start of each OFDM symbol, where l′=(nₛmod2)·N_{symb}^{DL}+l is the symbol number within a subframe 504.

In yet another embodiment, the scrambling sequence generation for downlink MBSFN-specific reference signals is changed to initiate at the start of each frame 500 and vary over each frame. In such embodiment, the new MBSFN-specific reference signal sequence r_{l,n}_{ₛ}(m) is defined by:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 360 \cdot {N}_{RB}^{max , DL} - 1. \qquad [ Eqn . 15 ]$$

In Equation 15, ns is the slot number 502 within a radio frame 500 and l is an OFDM symbol within the slot 502. The pseudo-random sequence c(i) is defined by Equations 4, 5 and 6 discussed herein above. The pseudo-random sequence generator is initialized with cᵢₙᵢₜ=N_{ID}^{MBSFN} at the start of each frame 500 (e.g., at the start of each 10 ms frame 500).

In still another embodiment, the scrambling sequence generation for downlink MBSFN-specific reference signals is changed to initiate at the start of each frame 500 based upon slot 502 and OFDM symbol. In such embodiment, the new MBSFN-specific reference signal sequence r_{l,n}_{ₛ}(m) is defined by:

$${r}_{l , {n}_{s}} ( m ) = \frac{1}{\sqrt{2}} ( 1 - 2 \cdot c ( 2 m + {l}^{′} ) ) + j \frac{1}{\sqrt{2}} ( 1 - 2 \cdot c ( 2 m + 1 + {l}^{′} ) ) , \\ for m = 0 , 1 , … 6 \cdot {N}_{RB}^{max , DL} - 1. \qquad [ Eqn . 16 ]$$

In Equation 16, nₛ is the slot number 502 within a radio frame 500 and l is the OFDM symbol within the slot 502. Further, l′ is defined as follows:

$$\begin{matrix}{l}^{′} = 12 {N}_{RB}^{max , DL} \cdot ( 2 {n}_{s} + ⌊ \frac{2 l}{{N}_{symb}^{DL}} ⌋ ) , \\ or & [ Eqn . 17 ] \\ {l}^{′} = 12 {N}_{RB}^{max , DL} \cdot ( 3 \cdot ⌊ \frac{{n}_{s}}{2} ⌋ + ⌊ \frac{3 l}{2 {N}_{symb}^{DL}} ⌋ ) . & [ Eqn . 18 ]\end{matrix}$$

The pseudo-random sequence c(i) is defined by Equations 4, 5 and 6 discussed herein above. The pseudo-random sequence generator is initialized with cᵢₙᵢₜ=N_{ID}^{MBSFN} at the start of each frame 500 (e.g., at the start of each 10 ms frame 500).

In an additional embodiment the scrambling sequence generation for downlink MBSFN specific reference signals is changed with a new logic incorporated. In such embodiment, the new cell-specific reference signal sequence r_{l,n}_{ₛ}(m) is defined by:

$${r}_{l , {n}_{s}} ( m ) = \frac{1}{\sqrt{2}} ( 1 - 2 \cdot c ( 2 m + {N}_{c}^{′} ) ) + j \frac{1}{\sqrt{2}} ( 1 - 2 \cdot c ( 2 m + 1 + {N}_{c}^{′} ) ) , \\ for m = 0 , 1 , … 6 \cdot {N}_{RB}^{max , DL} - 1. \qquad [ Eqn . 19 ]$$

In Equation 19, nₛ is the slot number 502 within a radio frame 500 and l is an OFDM symbol within the slot 502. Further, l′ is defined as follows:

N′_{c}=mod(N_{ID}^{MBSFN}×(N_{Num}^{Symbol}×16+N_{Num}^{Subfram}), 509). [Eqn. 20]

The pseudo-random sequence c(i) is defined by Equations 4, 5 and 6 discussed herein above. The pseudo-random sequence generator is initialized with cᵢₙᵢₜ=N_{ID}^{MBSFN} at the start of each frame 500. Therefore, a different subsequence of the reference signal sequence is applied to each subframe.

In alternate embodiments, the initialization seed cᵢₙᵢₜ is initialized every subframe 504. In such embodiments, the reference signal is variable over each subframe based upon the initialization seed.

In one such embodiment, the initialization seed cᵢₙᵢₜ is based on a convolutional code. The output of a convolutional encoder is truncated to a sequence of thirty-one (31) bits.

In another such embodiment, the initialization seed cᵢₙᵢₜ for the downlink cell-specific reference signal is based on:

cᵢₙᵢₜ=(N_{Num}^{Subfram}+1)×(N_{Num}^{Symbol}+1)×(N_{ID}^{Cell}+1)×2⁹+N_{ID}^{Cell}. [Eqn. 21]

In another such embodiment, the initialization seed cᵢₙᵢₜ for the downlink MBSFN reference signal is based on:

cᵢₙᵢₜ=(N_{Num}^{Subfram}+1)×(N_{Num}^{Symbol}+1)×(N_{ID}^{MBSFN}+1)×2⁹+N_{ID}^{MBSFN}. [Eqn. 22]

In another such embodiment, the initialization seed cᵢₙᵢₜ for the downlink cell-specific reference signal is based on:

cᵢₙᵢₜ=(N_{ID}^{Cell}+K₁)×(N_{Num}^{Symbol}+K₂)×(N_{Num}^{Subfram}+K₃)×(N_{Num}^{Symbol}+K₄)×(N_{ID}^{Cell}+K₅). [Eqn. 23]

In Equation 23, K₁, K₂, K₃, K₄, and K₅ are constants. For example, the values of K may be: K₁=3, K₂=3 and K₃=K₄=K₅=1. In such example, Equation 23 is:

cᵢₙᵢₜ=(N_{ID}^{Cell}+3)×(N_{Num}^{Symbol}+3)×(N_{Num}^{Subfram}+1)×(N_{Num}^{Symbol}+1)×(N_{ID}^{Cell}+1). [Eqn. 23]

In another such embodiment, the initialization seed cᵢₙᵢₜ for the downlink MBSFN reference signal is based on:

cᵢₙᵢₜ=(N_{ID}^{Cell}+K₁)×(N_{Num}^{Subfram}+K₂)×(N_{Num}^{Subfram}+K₃)×(N_{Num}^{Symbol}+K₄)×(N_{ID}^{Cell}+K₅). [Eqn. 24]

In Equation 24, K₁, K₂, K₃, K₄, and K₅ are constants. For example, the values of K may be: K₁=3, K₂=3 and K₃=K₄=K₅=1. In such example, Equation 24 is:

cᵢₙᵢₜ=(N_{ID}^{Cell}+3)×(N_{Num}^{Subfram}+3)×(N_{Num}^{Subfram}+1)×(N_{Num}^{Symbol}+1)×(N_{ID}^{Cell}+1). [Eqn. 24]

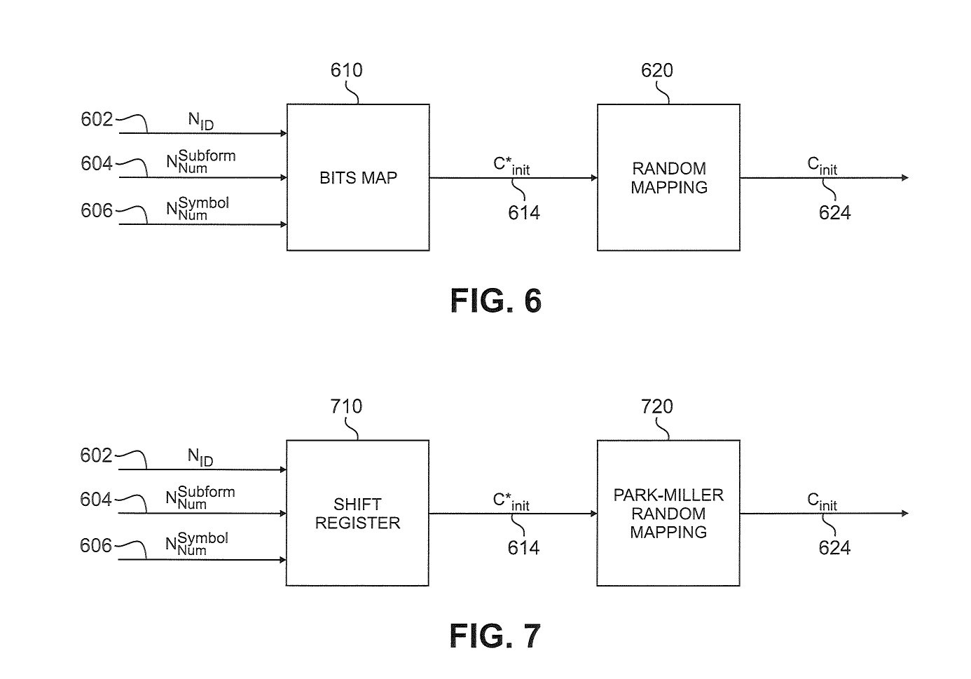

In an additional embodiment, the initialization seed cᵢₙᵢₜ is randomized. As illustrated in FIG. 6, the initialization seed cᵢₙᵢₜ is a function of three input sequences: N_{ID} 602, N_{Num}^{Subfram} 604, and N_{Num}^{Symbol} 606. N_{ID} 602 is the Cell_ID for the cell-specific downlink reference signal. Additionally, in MBSFN systems, N_{ID} 602 is the MBSFN_Area_ID for the MBSFN reference signal.

The three input sequences (N_{ID} 602, N_{Num}^{Subfram} 604, and N_{Num}^{Symbol} 606) are input into a Bits Map block 610. The Bits Map 610 block maps the three inputs (N_{ID} 602, N_{Num}^{Subfram} 604, and N_{Num}^{Symbol} 606) into a thirty-one (31) bit sequence. The 31-bit output of the Bits Map 610 is cᵢₙᵢₜ* 614. Additionally, the Bits Map block 610 is adapted to be applied to other embodiments that map seventeen (17) bits to a thirty-one (31) bit sequence including Equation 23 as illustrated below:

cᵢₙᵢₜ*=(N_{ID}^{Cell}+K₁)×(N_{Num}^{Subfram}+K₂)×(N_{Num}^{Subfram}+K₃)×(N_{Num}^{Symbol}+K₄)×(N_{ID}^{Cell}+K₅). [Eqn. 23]

The output of the Bits map 610 (i.e. cᵢₙᵢₜ* 614) is input into a Random Interleaver block 620. The Random Interleaver 620 performs a random mapping (e.g., a hashing) of 31-bit sequence cᵢₙᵢₜ* 614. The Random Interleaver 620 generates an output of cᵢₙᵢₜ 624.

In one embodiment, illustrated in FIG. 7, the Bits Map 610 is a “shift register” 710. The shift register 710 constructs a bit sequence based upon the shifted sum of N_{ID} 602, N_{Num}^{Subfram} 604, and N_{Num}^{Symbol} 606. Thereafter, the shift register 710 shifts the obtained sequence to become a 31-bit sequence. For example, the shift register 710 for a cell-specific downlink reference signal can be defined by:

cᵢₙᵢₜ*=N_{ID}^{Cell}×2¹⁴+N_{Num}^{Subfram}×2²³+N_{Num}^{Symbol}×2²⁷. [Eqn. 25]

In another embodiment, the Bits Map 610 is a “linear mapper” 610. The linear mapper 610 constructs a 31-bit sequence based on a linear function of N_{ID} 602, N_{Num}^{Subfram} 604, and N_{Num}^{Symbol} 606. For example, the linear mapper 610 for a cell-specific downlink reference signal is defined by:

cᵢₙᵢₜ*=N_{ID}^{Cell}+(N_{Num}^{Subfram}+1)×2⁹+(N_{ID}^{Cell}+1)×(N_{Num}^{Subfram}+1)×(N_{Num}^{Symbol}+1)×2¹³. [Eqn. 26]

In another embodiment, the random interleaver 620 is a Park-Miller random mapping block 720. The Park-Miller random mapping 720 is a variant of linear congruential mapping that operates in multiplicative group of integers modulo n. The general formula of this mapping can be written as:

cᵢₙᵢₜ=cᵢₙᵢₜ*×g mod n. [Eqn. 27]

In Equation 27, n is a prime number of to the power of a prime number and g is an element of high multiplicative order modulo n (e.g., a primitive root modulo n). In one example, n is assigned a value such that n=2³¹−1=2147483647 (e.g., a Mersenne prime M₃₁) and g=16807 (e.g., a primitive root modulo M₃₁).

The scrambling sequence generator 202 has been illustrated as located within a base station 102. In such embodiments, the subscriber station 116 is suitably adapted to perform reverse algorithms to decode the initialization seed and to recognize different seeds based on the subframe 504 and frame 500 (e.g., initialization seed based on a 1 ms subframe or a 10 ms frame). Additionally, the scrambling sequence generator 202 may be located within the SS 116. In such embodiments, the base station 102 is suitably adapted to perform reverse algorithms to decode the initialization seed and to recognize different seeds based on the subframe 504 and frame 500 (e.g., initialization seed based on a 1 ms subframe or a 10 ms frame).

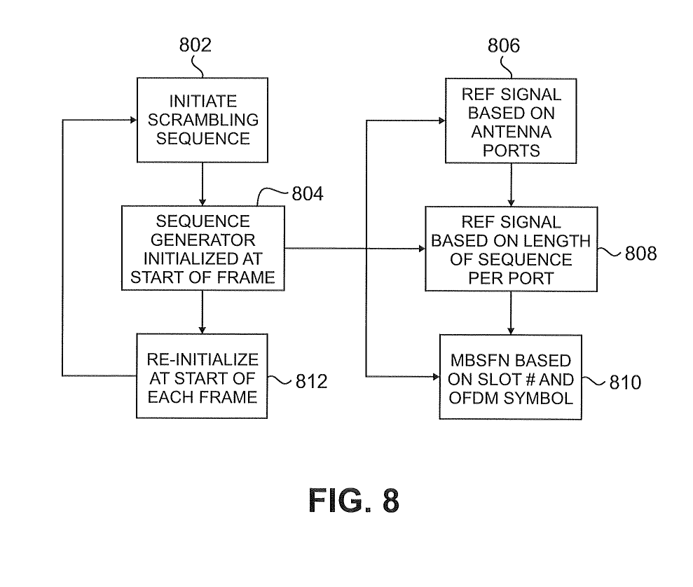

Referring now to FIG. 8, a simple block diagram for generating a frame variable reference signal according to embodiments of the present disclosure is illustrated. A scrambling sequence is initiated in step 802. At the start of a 10 ms frame, a pseudo-random sequence generator is initialized with an initialization seed (c_{INIT}) in step 804. The reference signal may be generated based on different antenna ports in step 806 or based upon length of sequence per antenna port in step 808. Alternatively, the reference signal, for MBSFN, may be generated based on slot number and OFDM symbol in step 810. Thereafter, step 812 illustrates that the pseudo-random sequence generator is initialized at the start of each 10 ms frame.

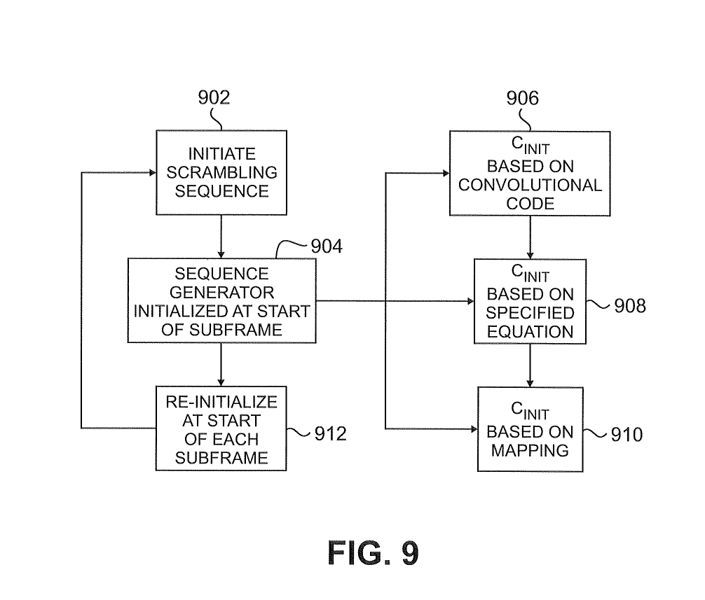

Referring now to FIG. 9, a simple block diagram for generating an initialization seed for generating a variable reference signal sequence according to embodiments of the present disclosure is illustrated. A scrambling sequence is initiated in step 902. At the start of a 1 ms subframe, a pseudo-random sequence generator is initialized with an initialization seed (c_{INIT}) in step 904. The initialization seed (c_{INIT}) is constructed based on a convolutional code in step 906 or based on one of several equations (e.g., Equations 21-23) in step 908. Alternatively, initialization seed (c_{INIT}) is generated via a Bits Mapping and Random Mapping in step 910. Additionally in step 910, the Bits Mapping may be a shift register or linear mapping process. Further in step 910, the random mapping may be a Park-Miller random mapping process or a Lehmer random mapping process. Thereafter, step 912 illustrates that the pseudo-random sequence generator is initialized at the start of each 1 ms subframe.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for use in a wireless communication network capable of generating a reference signal, said apparatus comprising:
a scrambling sequence generator adapted to initialize at the start of a radio frame, said scrambling sequence generator operable to generate a variable reference signal; and
a plurality of transmission antenna adapted to transmit said variable reference signal.

2. The apparatus as set forth in claim 1, wherein said scrambling sequence generator is adapted to generate said variable reference signal based on an antenna port.

3. The apparatus as set forth in claim 1, wherein said scrambling sequence generator is adapted to generate said variable reference signal based on a different sequence length per each of said plurality of antenna ports.

4. The apparatus as set forth in claim 1, wherein said scrambling sequence generator is adapted to generate said variable reference signal based on a same sequence length per each of said plurality of antenna ports.

5. The apparatus as set forth in claim 1, wherein radio frame is 10 millisecond frame.

6. The apparatus as set forth in claim 1, wherein said scrambling sequence generator is adapted to initialize, by an initialization seed, at the start of a subframe.

7. The apparatus as set forth in claim 6, wherein said initialization seed is constructed based on a convolutional code.

8. The apparatus as set forth in claim 6, wherein said apparatus further comprises a mapping processor adapted to construct said initialization seed as a function of three inputs, said mapping processor further comprising:
a bits map processor for mapping said three inputs as a 31-bit sequence, and
a random mapping processor for hashing said 31-bit sequence to generate said initialization seed.

9. The apparatus as set forth in claim 8, wherein said bits map processor is a shift register.

10. The apparatus as set forth in claim 8, wherein said bits map processor is a linear mapping processor.

11. The apparatus as set forth in claim 8, wherein said random mapping processor is a Park-Miller random mapping processor.

12. For use in a communication node capable of transmitting a reference signal, a method of generating the reference signal, the method comprising the steps of:
initializing a scrambling sequence generator at the start of a radio frame;
generating a variable reference signal based on an initialization seed; and
transmitting the variable reference signal via a plurality of transmission antenna.

13. The method as set forth in claim 12, further comprising the step of generating the variable reference signal based on an antenna port.

14. The method as set forth in claim 12, further comprising the step of generating the variable reference signal based on a sequence length per each of the plurality of transmission antennas.

15. The method as set forth in claim 12, wherein the step of initializing further comprising initializing the sequence generator at the start of a radio subframe.

16. The method as set forth in claim 15, further comprising constructing the initialization seed based on a convolutional code.

17. The method as set forth in claim 15, further comprising constructing the initialization seed by:
mapping three inputs as a 31-bit sequence; and
hashing the 31-bit sequence to generate the initialization seed.

18. The method set forth in claim 17, wherein mapping the three inputs is performed by a shift register.

19. The method as set forth in claim 17, wherein mapping the three inputs is performed by a linear mapping processor.

20. The method as set forth in claim 17, wherein hashing the 31-bit sequence is performed by a Park-Miller random mapping processor.

21. A wireless network comprising a plurality of communication nodes, at least one of said communication nodes capable of transmitting a radio frame containing a reference signal, said each wireless network comprising:
a first communication node capable of generating a variable reference signal sequence; and
a second communication node capable of decoding said variable reference signal sequence, wherein said variable reference signal sequence is initialized at the start of each of a plurality of radio frames.
